(19) United States
(12) Patent Application Publication
(10) Pub. No.: US 2003/0159466 A1
(43) Pub. Date: Aug. 28, 2003

(54) Dry pressing of spray dried soot to make EUV components

(76) Inventors: Bradley F. Bowden, Alfred, NY (US); Kenneth E. Hrdina, Horseheads, NY (US)

Correspondence Address: CORNING INCORPORATED, SP-TI-3-1, CORNING, NY, 14831

(21) Appl. No.: 10/085,838

(22) Filed: Feb. 27, 2002

(51) Int. Cl. C03B 19/09

(52) U.S. Cl. 65/17.6

(57) ABSTRACT

The present invention is directed to a method for producing optical blanks for EUV microlithographic components. The method includes the step of providing soot particles and spray-drying the soot particles to form an agglomerate. The agglomerate is dry-pressed to form a green body. The green body is heated to form a glass object. The method of the present invention produces optical components having substantially no striae. Further, the method of the present invention produces optical blanks having substantially no low frequency thickness variation. As a result, scattering is substantially reduced when EUV light is reflected from a component produced from the optical blank.

### BACKGROUND OF THE INVENTION

1. Field of the Invention

The present invention relates generally to a method for making glass, and particularly to a method for making high purity fused silica glass or ultra-low expansion glass.

2. Technical Background

Integrated circuits (ICs) are fabricated using microlithographic systems. The goal of IC manufacturers is to produce integrated circuits having linewidths as small as possible. Most of the microlithographic systems currently in use employ transmission optics. The typical system includes an illumination source coupled to an illumination optics assembly which provides a photomask with illumination light. The illumination optics expand and collimate the laser light to thereby homogenize the light intensity. The photomask carries the image of an integrated circuit. The photomask is positioned between the illumination optics and a projection optical system. The projection optical system projects the image of the integrated circuit onto the semiconductor substrate. Both the illumination optical system, the photomask, and the projection optical system employ transmission optics. It was once thought that the limit of making integrated circuits using transmission optics would be somewhere around one micron; however, various improvements have been made such that one-tenth micron feature sizes are currently being produced.

One way of reducing the linewidth is to improve the quality of the optical components. Another way of reducing the linewidth is to reduce the wavelength of the laser light source. For example, KrF lasers, which operate at a wavelength of 248 nm, are capable of producing integrated circuits having linewidths approaching 120 nm. ArF lasers represent an improvement over KrF lasers, operating at a wavelength of 193 nm. With improvements to the transmission optics, integrated circuits can theoretically be produced with linewidths as small as 70 nm. Designers are now considering F₂ lasers. These lasers operate at a wavelength of 157 nm. F₂ lasers hold the promise of producing integrated circuits having linewidths on the order of 50 nm.

While it may be possible to further reduce the operating wavelength of light sources used in illumination systems, the very use of transmission optics is becoming a limiting factor. The problem is that the glass materials currently employed are not transparent at shorter wavelengths. Integrated circuit manufacturers have seen this problem coming for some time and are investigating ways of overcoming the above described limitations.

In one very promising approach, designers are considering reflective optical microlithographic systems that employ extreme ultraviolet (EUV) illumination sources. EUV systems operate at wavelengths in an approximate range between 11 nm and 13 nm. Instead of transmitting light through lens systems, reflective optical systems employ mirrors to direct the light onto the semiconductor substrate. The photomasks used in EUV systems are also reflective. Because the wavelengths in EUV systems are so short, any irregularity present on the surface of a mirror will significantly degrade system performance. Thus, the optical blanks used to produce EUV mirrors must be of the highest quality.

Quality optical blanks useful in current microlithographic systems are being produced using a flame hydrolysis process. A mixture of silica precursor and a very pure titania precursor are delivered in vapor form to a flame forming SiO₂—TiO₂ soot particles. The soot particles melt in layers forming a solid fused silica optical blank. This method can be used to produce high quality optical components for transmissive devices and EUV compatible optical components. However, one problem being encountered in the fabrication of mirrors is the presence of striae in the optical blank. Another problem with the above described process relates to the low frequency inhomogeneities present in the resultant optical blank. Another problem involves the surface roughness of the resultant optical blank. Both the surface roughness and the low frequency inhomogeneity result in less than perfect performance when the EUV light is reflected from the mirror surface.

What is needed is a method for producing EUV compatible optical blanks for use in reflective microlithography. A method is needed to produce optical blanks having substantially no striae and no low frequency compositional variations.

### SUMMARY OF THE INVENTION

The present invention relates to a method for producing optical blanks or photomasks subsystems for EUV microlithographic components. The method of the present invention produces optical blanks having substantially no striae and substantially no low frequency compositional variations. As a result, distortion is substantially reduced when EUV light is reflected from a component produced from the optical blank.

One aspect of the present invention is a method for forming an optical blank. The method includes the step of providing soot particles. The soot particles are spray-dried to form an agglomerate. The agglomerate is dry-pressed to form a green body. The green body is heated to form a glass object.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a schematic of a system for producing soot particles in accordance with one embodiment of the present invention;

FIG. 2 is a schematic of a system for spray drying soot particles to form an agglomerate in accordance with the present invention;

FIG. 3A is an optical micrograph of an agglomerate produced in accordance with the present invention;

FIG. 3B is an optical micrograph of the agglomerate shown in FIG. 3A immersed in an index-matching oil;

FIG. 3C is an optical micrograph of an agglomerate produced in accordance with the present invention, the agglomerate being immersed in an index-matching oil; and

FIG. 4 is a perspective view of a green body produced in accordance with the present invention.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

In accordance with the invention, the present invention relates to a method for producing optical blanks for use in the fabrication of reflective EUV microlithographic components. The method includes the step of providing soot particles. The soot particles are spray-dried to form an agglomerate. The agglomerate is dry-pressed to form a green body. The green body is heated to form a glass object. The method of the present invention produces optical components having substantially no striae and substantially no low frequency compositional variations. As a result, scattering is substantially reduced when EUV light is reflected from a component produced from the optical blank.

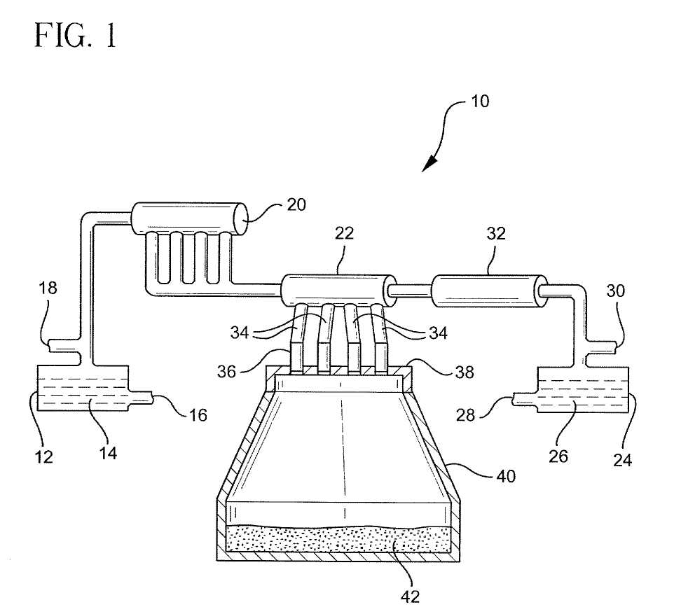

As embodied herein, and depicted in FIG. 1, a schematic of system 10 for producing soot particles in accordance with one embodiment of the present invention is disclosed. System 10 includes a source of silica precursor 14. A carrier gas 16, such as nitrogen, is introduced at or near the base of source 12. A bypass stream of carrier gas is introduced at 18 to prevent saturation of the vaporous stream. The vaporous stream passes through distribution system 20 to manifold 22. System 10 also includes source 24 of the titania precursor 26. Source 24 also has inlet 28 for a carrier gas that is transmitted through precursor material 26. A by-pass stream is introduced at 30. The vaporous stream passes through distribution system 32 to manifold 22.

The silica vapor stream and the titania vapor stream mix in manifold 22. The mixture passes through fume lines 34 to burners 36 mounted in upper portion of furnace 38. The mixed vapor stream is further joined with a fuel/oxygen mixture at burners 36. The vapor stream combusts and is oxidized to form silica-titania particles at a temperature in excess of 1600° C. The particles cool and are directed into collection chamber 40. There the particles form a layer of pure ULE or HPFS soot 42.

In another embodiment, soot particles 42 are formed as a by-product of a flame hydrolysis process used to make the ultra-low expansion (ULE) glass and High Purity Fused Silica (HPFS) glass manufactured by Corning Incorporated. In this embodiment, after the vapor stream combusts and is oxidized, forming silica-titania particles, the particles are directed into a cup in the refractory furnace where they melt to form a green body. However, a significant portion of the glass particles 42 are deposited in the cup, but rather are drawn out of the furnace where they cool and are collected in a bag house. One problem associated with this method is the presence of many impurities and foreign materials in the bag house. Many of these contaminants find their way into soot 42. In another embodiment, the above described problems are substantially eliminated by filtering the air to minimize the impurities.

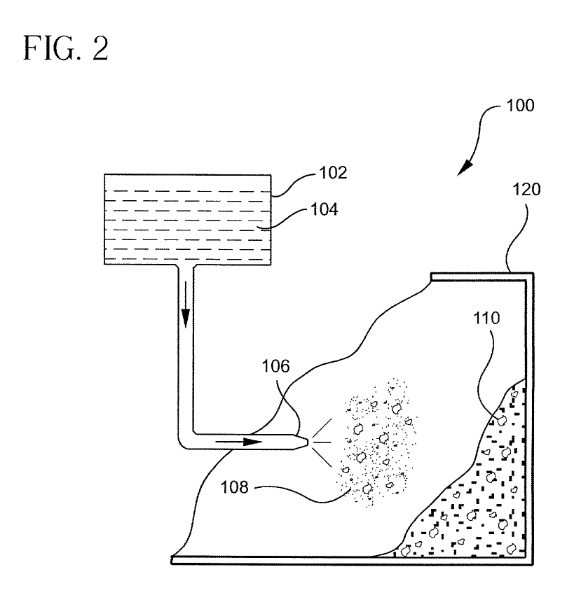

After soot 42 is provided using one of the two above described methods, soot 42 is mixed with water in a 50-50 weight percent suspension to create a slurry. In one embodiment, an ammonia hydroxide dispersant is added to the slurry. In another embodiment no dispersant is added to the slurry. As embodied herein, and depicted in FIG. 2, a schematic of system 100 for spray drying the slurry to form an agglomerate in accordance with the present invention is disclosed. System 100 includes pressurized source 102 of slurry 104. Slurry 104 is directed to nozzle 106 where atomized slurry 108 is discharged into environmental chamber 120 where it dries to form agglomerate 110. The temperature within environmental chamber 120 is maintained within an approximate range between 90° C. and 300° C.

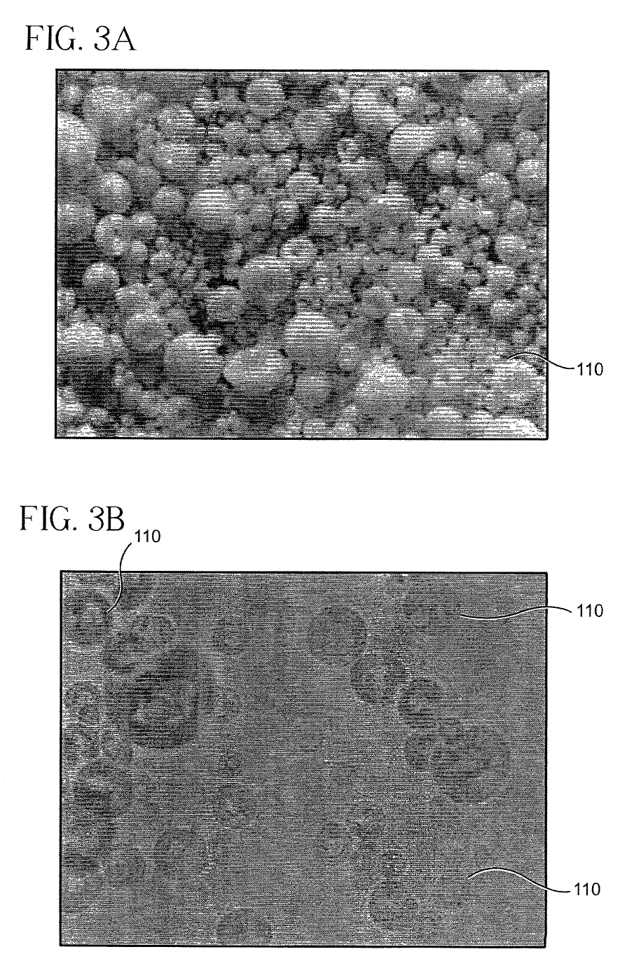

FIG. 3A is an optical micrograph of the agglomerate 110. Agglomerates 110 have a diameter in the approximate range between 10 and 200 microns. FIG. 3B is an optical micrograph of the agglomerates shown in FIG. 3A, immersed in an index-matching oil. In this embodiment, an ammonia hydroxide dispersant is employed. Note that agglomerates 110 include hollow spheres. FIG. 3C is an optical micrograph of the agglomerates 110 immersed in an index-matching oil. In this embodiment, the ammonia hydroxide dispersant is not employed. The use of undispersed or partially flocculated slurry suspension 104 results in solid agglomerates 110 having a uniform granule density.

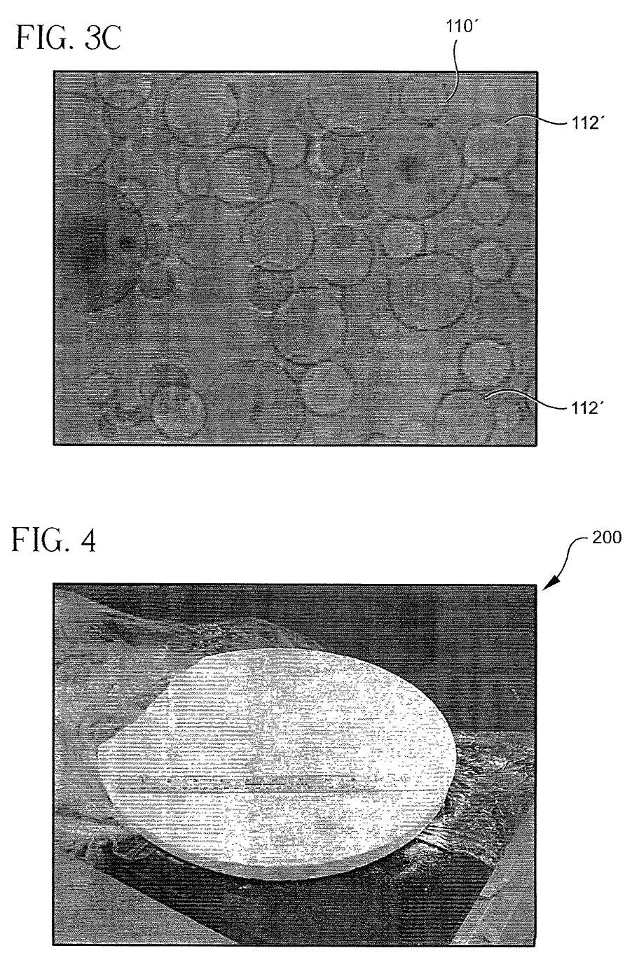

As embodied herein, and depicted in FIG. 4, a perspective view of green body 200 produced in accordance with the present invention is disclosed. Agglomerate 110 is fed into a hydraulic press. Green body 200 is formed by compacting agglomerate 110 at room temperature. The pressure applied is in the approximate range between 1,000 Psi and 10,000 Psi. A photomask preform pressed at 5000 Psi would require a 125 ton press, which is well within current commercial applications. In an alternate embodiment, agglomerate 110 is uniaxially dry pressed into approximately 1-inch diameter pellets using a small hydraulic press. Pressure of 3000 Psi and 5000 Psi yielded pellets of 56 and 58 percent of theoretical density, respectively.

If the green body is produced using high purity soot (see FIG. 1), cleaning may not be necessary. If the soot is formed as a by-product of the flame hydrolysis process used to make the ultra-low expansion (ULE) glass and High Purity Fused Silica (HPFS) glass manufactured by Corning Incorporated, then it must be cleaned because it may contain impurities and/or other foreign materials. When the soot is formed as a by-product of ULE or HPFS processes, little effort is made to maintain their purity when they are collected in the bag house. Most of the organic impurities are burned out during presintering, but inorganic impurities remain throughout the process of making the glass.

High temperature chlorine gas treatment is a technique that is used to remove the impurities such as alkalis, iron, and water from porous bodies. At high temperatures, chlorine gas reacts with the impurities to form compounds which are vaporized and carried out of the substrate with flowing chlorine and a carrier gas such as helium or oxygen. The chlorine treatment reduces contamination from both the soot forming and the green body forming processes. Furthermore, a significant amount of impurities observed in the final glass body can be attributed to green body forming operations. To be effective, the chlorine gas must diffuse through the porosity of the part and reach the surface of the soot particles.

Table I provides one possible schedule used for chlorine treatment of ULE green bodies. During each chlorine cycle a mixture of 20% helium and 80% chlorine gas flows within the furnace for one hour. The furnace reaches a maximum pressure of about 500 torr. After one hour the chlorine flow is arrested and the furnace is evacuated to about 5 torr with continued helium flow. Other heat treatments may be used that employ Oxygen instead of helium. The vacuum is maintained for thirty minutes after which another cycle begins.

TABLE I

| | Set Point | Heating Rate | |
|---|---|---|---|
| Segment | (° C.) | (° C./min) | Conditions |
| 1 | 825 | 2 | Vacuum w/ minimum He flow |
| 2 | 825 | — | Up to 6 chlorine cycles |
| 3 | Room Temp. | Furnace Cool | Vacuum w/ minimum He flow |

The green body is consolidated into an optical blank by applying heat. In one embodiment, the green body is heated in a He atmosphere. The approximate temperature range is between 1400° C. and 1800° C. In another embodiment, the green body is heated in a vacuum. Again, the approximate temperature range is between 1400° C. and 1800° C. The sintering of glass particles is achieved via viscous flow, and is therefore time and temperature dependent. The sintering temperature applied for ULE glass is typically greater than 1300° C. High purity fused silica is typically sintered at a temperature greater than 1350° C., but the sintering temperature can be higher, depending on the particle size. An example sintering schedule includes a 5° C./min heating rate to 1400-1450° C. with a 0-5 minute hold, followed by rapid cooling at approximately 20° C./min to about 100° C. An acceptable annealing cycle to room temperature may follow.

In another embodiment, the chlorine treatment and sintering of HPFS bodies are performed by using a single process. Table II shows one possible schedule for chlorine treatment and sintering of processed HPFS bodies.

TABLE II

| | Set Point | Heating Rate | |
|---|---|---|---|
| Segment | (° C.) | (° C./min) | Conditions |
| 1 | 950 | 2 | Vacuum w/ minimum He flow |
| 2 | 950 | — | Up to 6 chlorine cycles |
| 3 | 1400 | 4 | Vacuum with minimum |
| | | | He flow |
| 4 | Room Temp. | Furnace Cool | Furnace is back-filled with |
| | | | non-He gas to promote void |
| | | | collapse via He dispersion |

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for forming an optical blank, the method comprising:
providing soot particles;
spray-drying the soot particles to form an agglomerate;
dry-pressing the agglomerate to form a green body; and
heating the green body to form a glass object.

2. The method of claim 1, wherein the step of providing soot particles includes forming soot particles as a by-product of a flame hydrolysis process.

3. The method of claim 2, further comprising the step of cleaning the green body to remove impurities.

4. The method of claim 3, wherein the step of cleaning further comprises:
disposing the green body in a high temperature chlorine gas atmosphere, the high temperature being lower than a sintering temperature; and
treating the green body by allowing the chlorine gas to react with the impurities for a predetermined time.

5. The method of claim 4, wherein the high temperature is between 700° C. and 100° C.

6. The method of claim 1, wherein the step of spray-drying further comprises:
mixing the soot particles with water to form a slurry;
discharging the slurry through a nozzle to form a plurality of slurry droplets; and
drying the plurality of droplets to form the agglomerate.

7. The method of claim 6 wherein the slurry does not include a dispersant.

8. The method of claim 7, wherein the agglomerate includes a plurality of silica containing solid spheres.

9. The method of claim 8, wherein the plurality of silica containing solid spheres have a diameter substantially within the range of 10 to 200 microns.

10. The method of claim 6, wherein the slurry includes a dispersant.

11. The method of claim 10, wherein the agglomerate includes a plurality of silica containing hollow spheres.

12. The method of claim 11, wherein the plurality of silica containing hollow spheres have a diameter substantially within the range of 10 to 200 microns.

13. The method of claim 10, wherein the dispersant includes ammonia hydroxide.

14. The method of claim 6, wherein the slurry is substantially a 50 weight percent soot suspension.

15. The method of claim 6, wherein the slurry includes a binder agent.

16. The method of claim 15, wherein the binder agent is substantially a 3 weight percent polyethylene glycol suspension.

17. The method of claim 1, wherein the agglomerate includes granules having a diameter substantially within the range of 10 to 200 microns.

18. The method of claim 1, wherein the agglomerate has a bulk density in the approximate range between 30-50%.

19. The method of claim 1, wherein the step of dry-pressing includes dry pressing the agglomerate at pressure substantially in the range between 1,000 Psi and 10,000 Psi.

20. The method of claim 19, wherein the step of dry-pressing includes the step of forming pellets.

21. The method of claim 1, wherein the step of heating includes the step of sintering the green body.

22. The method of claim 21, wherein the step of sintering the green body is performed at a temperature above 1100° C.

23. The method of claim 22, wherein the green body is sintered at a temperature of approximately 1400° C.

24. The method of claim 22, wherein the green body is sintered at a temperature of approximately 1500° C.

25. The method of claim 21, wherein the step of sintering further comprises:
disposing the green body in a high temperature chlorine gas atmosphere, the high temperature being lower than a sintering temperature; and
treating the green body by allowing the chlorine gas to react with the impurities for a pre-determined time.

26. The method of claim 21, wherein the step of sintering is performed in a substantial vacuum.

27. The method of claim 21, wherein the step of sintering is performed in a helium atmosphere.

28. The method of claim 1, wherein the step of heating includes heating the green body to a temperature substantially within a range between 1350° C. and 1800° C.

29. The method of claim 28, wherein the step of heating is performed in a vacuum chamber.

30. The method of claim 28, wherein the step of heating is performed in a helium atmosphere.
